(19) United States
(12) Patent Application Publication
(10) Pub. No.: US 2010/0201191 A1
(43) Pub. Date: Aug. 12, 2010

(54) Power Supply For By-Wire System

(76) Inventors: Troy Eugene Schick, Cedar Falls, IA (US); Joseph Paul Kearney, Cedar Falls, IA (US); Dawn C. Willett, Moorhead, MN (US); Joseph J. Soldwisch, Waverly, IA (US); Don L. Bloomquist, JR., Waterloo, IA (US)

Correspondence Address: DEERE & COMPANY, ONE JOHN DEERE PLACE, MOLINE, IL, 61265, US

(21) Appl. No.: 12/369,318

(22) Filed: Feb. 11, 2009

(51) Int. Cl. B60L 1/00

(52) U.S. Cl. 307/10.1

(57) ABSTRACT

The invention relates to an electric power supply system for a by-wire vehicle system. There is a need for a power supply system which allows the integrity of the battery and alternator to be monitored. A vehicle electric power supply system includes a battery, an alternator, a key operated switch and at least two electronic control units (ECUs). A battery line is connected to the battery, to the second ECU, and to the key switch. An alternator line connects the alternator to the first ECU and to the key switch. A relay includes a relay switch which opens and closes a connection between the battery line and the alternator line. A relay coil is energizable to cause the relay switch to connect the battery line to the alternator line. Energization of the relay coil is controlled by one of the ECUs. This ECU causes the relay coil to move the switch element disconnect the alternator line from the battery line so that voltage from the alternator and battery can be independently tested.

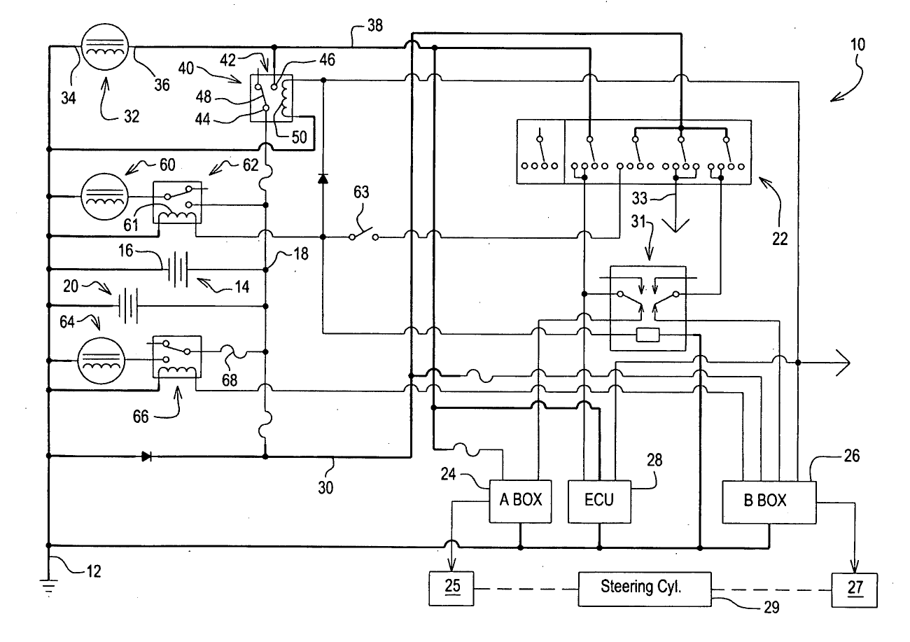

### FIELD OF THE INVENTION

The present invention relates to a power supply for a by-wire system.

### BACKGROUND OF THE INVENTION

A by-wire steering system or a by-wire brake system in a vehicle eliminates the mechanical link between the steering wheel (or the brake pedals) and the road wheels, and permits the system to achieve a desirable steering “feel” or other control characteristic. Such “by-wire” systems have been difficult to implement in vehicles because of cost, reliability and precision requirements.

In a full by-wire system, the integrity of the electrical power system must be monitored. This includes checking the presence and health of both the battery and the alternator. However, batteries and alternators on vehicles today are directly connected. This makes it difficult to accomplish on-board evaluation of these components.

### SUMMARY OF THE INVENTION

Accordingly, an object of this invention is to provide a vehicle electric power supply system.

A further object of the invention is to provide such a power supply system which allows the integrity of the battery and alternator to be monitored.

A further object of the invention is to provide such a power supply system for a vehicle by-wire system.

These and other objects are achieved by the present invention, wherein a vehicle electric power supply system includes a battery, an alternator, a key operated switch and at least two electronic control units (ECUs). A battery line is connected to the battery, to the second ECU, and to the key switch. An alternator line connects the alternator to the first ECU and to the key switch. A relay includes a relay switch having a first contact connected to the battery line, a second contact connected to the alternator line, and a switch element. The switch element is movable from a first position connecting the first contact to the second contact to a second position isolating the first contact from the second contact, and a relay coil which is energizable to move the switch element into its second position. Energization of the relay coil is controlled by one of the ECUs. This ECU causes the relay coil to move the switch element to its second position so that the second terminal of the alternator and battery are isolated from each other so that voltage from the alternator and battery can be independently tested.

### BRIEF DESCRIPTION OF THE DRAWINGS

The sole FIGURE is a circuit schematic of the invention.

### DESCRIPTION OF THE PREFERRED EMBODIMENT

A vehicle electric power supply system or circuit 10 includes an electrical ground 12. A battery 14 has a first terminal 16 connected to ground 12 and a second terminal 18. The system 10 may also include a similarly connected auxiliary battery 20, a key operated switch 22, a first electronic control unit (ECU) 24, a second ECU 26 and a third ECU 28 is available to control other vehicle functions (not shown). ECU 24 controls a first steering control valve 25. ECU 26 controls a second steering control valve 27. Steering control valves 26 and 27 control a conventional steering cylinder 29.

A battery line 30 is connected to the second terminal 18 of battery 14, to the second ECU 26, and to the key switch 22. An alternator 32 has a first terminal 34 connected to ground 12 and a second terminal 36. An alternator line 38 is connected to the second terminal 36 of the alternator 34, to the first ECU 24 and to the key switch 22.

A relay 40 includes a relay switch 42 having a first contact 44 connected to the battery line 30, a second contact 46 connected to the alternator line 38, a switch element 48 movable from a first position connecting the first contact 44 to the second contact 46 to a second position isolating the first contact 44 from the second contact 46. The relay 40 also includes a relay coil 50 which is energizable to move the switch element 48 into its second position. Energization of the relay coil 50 is controlled by one of the ECUs, such as the second ECU 26. ECU 26 causes the relay coil 50 to move the switch element 48 to its first position so that the second terminal 36 of the alternator 32 and battery 14, 20 are isolated from each other so that voltage from the alternator 32 and battery 14, 20 can be independently tested.

A starter 60 and a starter relay 62 are connected between ground 12 and battery line 30. A coil 61 of relay 62 and a neutral switch 63 are connected in series between ground 12 and a start terminal of the key switch 22.

An electric load, such as motor driven pump 64, a normally open pump motor relay 66 and a pump motor fuse 68 are connected in series between ground 12 and battery line 30. Relay 66 is controlled by ECU 26. ECU 26 can energize the coil of relay 66 to connect motor 64 to the battery line 30 while relay switch 42 is open. By connecting a load to the battery 14 through battery line 30, the function and capacity of the battery 14 can be tested or monitored in isolation from the alternator 32.

The ELX (switched power) signal is used to initiate the normal startup and shutdown sequences in the controllers. The normal startup sequence is initiated when the ELX signal transitions from off to on, and the normal shutdown sequence is initiated when the ELX signal transitions from on to off. The ELX signal is on when the key switch is in the “run” position and off in the “start” and “off” positions. The normally closed ELX relays are used to insure that the ELX signals are low when the key switch is in the “start” position.

Key switch 22 is a 4 position switch with “start”, “run”, “off” and “accessory” positions. In the start position the alternator line 38 is connected to an ignition input of ECU 28, and the battery line 30 is connected to neutral switch 63 and to an “ELX” relay 31. In the run position the alternator line 38 is connected to an ignition input of ECU 28, and the battery line 30 is connected to an accessory line 33 and to “ELX” relay 31. In the accessory position the alternator line 38 is not connected through switch 22, and the battery line 30 is connected to an accessory line 33.

Thus, this system includes a switch 40 between the battery 14 and the alternator 32. With the engine running, the switch 40 is opened, thus allowing the status of the alternator 32 and the battery 14 to be evaluated independently. The status of the alternator 32 is determined by checking the alternator output voltage and insuring that the engine continues to run (alternator maintains voltage under load). The status of the battery 14 is determined by monitoring battery voltage as a load, such as the electric pump 66 is cycled. After the battery 14 and alternator 32 have been checked, the switch 40 is kept closed to allow normal charging of the batteries 14, 20 by the alternator 32.

While the present invention has been described in conjunction with a specific embodiment, it is understood that many alternatives, modifications and variations will be apparent to those skilled in the art in light of the foregoing description. Accordingly, this invention is intended to embrace all such alternatives, modifications and variations which fall within the spirit and scope of the appended claims.

We claim:

1. A vehicle electric power supply system comprising:
a battery having a first terminal connected to ground and a second terminal;
a key operated switch;
a first electronic control unit (ECU);
a second ECU;
a battery line connected to the second terminal of the battery, connected to the second ECU, and connected to the key switch;
an alternator having a first terminal connected to ground and a second terminal,
an alternator line connecting to the second terminal of the alternator to the first ECU and to the key switch; and
a main relay comprising a relay switch having a first contact connected to the battery line, a second contact connected to the alternator line, a switch element movable from a first position connecting the first contact to the second contact to a second position isolating the first contact from the second contact, and a relay coil which is energizable to move the switch element into its second position, energization of the relay coil being controlled by one of the ECUs, said one ECU causing the relay coil to move the switch element to its second position so that the second terminal of the alternator and battery are isolated from each other so that voltage from the alternator and battery can be independently tested.

2. The power supply system of claim 1, wherein:
in response to a short circuit to ground of the alternator line, one of the ECUs opens the relay switch to isolate the battery line from the short circuit.

3. The power supply system of claim 1, wherein:
in response to a short circuit to ground of the battery line, one of the ECUs opens the relay switch to isolate the alternator line from the short circuit.

4. The power supply system of claim 1, further comprising:
an electric load and a normally open load relay connected in series between ground 12 and the battery line, the load relay being controlled by one of the ECUs, said ECU closing the load relay to connect the load to the battery line when the battery line is disconnected from the alternator line.

5. The power supply system of claim 1, wherein:
the ECUs are redundant controllers for a by-wire vehicle function.

6. The power supply system of claim 2, wherein:
the key switch controls communication between the battery line and the ECUs, and controls communication between the alternator line and the ECUs.

7. A vehicle electric power supply system comprising:
a battery having a first terminal connected to ground and a second terminal;
a battery line connected to the second terminal of the battery;
an alternator having a first terminal connected to ground and a second terminal;
an alternator line connecting to the second terminal of the alternator; and
a switch connected between the battery line and the alternator line, the switch being movable from a first position connecting the battery line to the alternator line to a second position isolating the battery line from the alternator line; and
an electronic control unit (ECU) connected to the battery line and to the switch, the ECU being operable to move the switch into its second position so that the second terminal of the alternator and battery are isolated from each other so that voltage from the alternator and battery can be independently tested, and the ECU being operable to move the switch into its first position so that the alternator can charge the battery.

8. A electric power supply system for a vehicle driven by an engine, the power supply system comprising:
a battery;
an alternator;
a switch between the battery and the alternator;
a control unit connected to the switch, to the battery and to the alternator, the control unit being operable to open the switch when the engine is running so that the status of the battery and the alternator can be independently evaluated, the control unit being operable, after the battery and alternator have been evaluated, to close the switch to allow normal charging of the battery by the alternator.
